(19) United States
(12) Patent Application Publication
(10) Pub. No.: US 2010/0137508 A1
(43) Pub. Date: Jun. 3, 2010

(54) METHOD AND HIGH-PRESSURE MIXING DEVICE FOR FILLED POLYURETHANE RESINS

(75) Inventor: Maurizio CORTI, Como (IT)

Correspondence Address: YOUNG & THOMPSON, 209 Madison Street, Suite 500, Alexandria, VA, 22314, US

(73) Assignee: AFROS S.P.A., Varese (IT)

(21) Appl. No.: 12/629,914

(22) Filed: Dec. 3, 2009

(30) Foreign Application Priority Data
Dec. 3, 2008 (IT) MI2008A 002137

(51) Int. Cl. C08L 75/04; B29B 7/90

(52) U.S. Cl. 524/590; 366/162.5; 366/134

(57) ABSTRACT

A method and device for high-pressure mixing of polyurethane components, in which one of the polyurethane components is pre-mixed with a filler material and/or with an additive. The device comprises a mixing chamber into which first and second polyurethane components are radially injected, and a slide valve which moves between a fore or closure position and a rear or opening position of the mixing chamber. The slide valve at its fore end is provided with a feeding chamber for a third polyurethane component pre-mixed with the filler material and/or additive, and an outlet hole; a cleaning pin for the outlet hole slides into a longitudinal guide hole of the slide valve.

### BACKGROUND OF THE INVENTION

This invention refers to high-pressure mixing device for chemically reactive polyurethane components, and in particular it is directed to a method and a mixing device of the referred type, suitable for mixing two or more polyurethane components, one or more of which have been appropriately pre-mixed with a powdered filler material, and/or with a chemically aggressive additive, which require feeding conditions suitable for preventing or impeding damage and malfunctioning of the mixing and auxiliary devices.

In the production of molded pieces in polyurethane material, it is often necessary to add powdered filler material and/or additives, both in order to reduce the costs of the molded articles and to considerably increase their resistance to fire, or to attribute specific features to them.

The fillers usually consist of powdered, and/or granulated, and/or flaked substances, or a liquid additive, which must be duly dispersed in the liquid polyurethane resin before the chemical reaction starts.

A device for the production of polyurethane foams containing an inert filler material is shown, for example, in U.S. Pat. No. 4,397,407. As may be read in this document, attempts have already been made to introduce a filler directly into the mixing device, together with polyurethane components, but were unsuccessful due to the abrasive nature of the filler material and also due to the need to use excessively high pressures.

According to said document, all this has made the use of traditional high-pressure mixing devices entirely inadequate and uneconomical.

U.S. Pat. No. 4,397,407 therefore proposes the use of a high-pressure mixing device, in which the polyurethane components are mixed in advance in a mixing chamber, and in which a powdered filler material is subsequently fed into the resulting polyurethane mixture while it is flowing into an annular channel.

Although U.S. Pat. No. 4,397,407 proposes a high-pressure mixing method and device with the aim of solving certain problems, the proposed solution nonetheless presents further limits and problems; a solution of this kind does not, in fact, ensure homogenous diffusion of the filler into the polyurethane mixture, since preferential flows may be generated, or floccules which, besides preventing dispersion, also obstruct the ducts, particularly if it is necessary to feed in large metered quantities of powdered or flaked material.

The general teaching obtainable from this document is therefore the post-mix the powdered or granulated filler material, in the already formed polyurethane mixture, presumably already in the reaction phase. Lastly, a mixing device of this type is extremely complex due to the need to include a filler material feeding system, downstream the mixing chamber and a mixture outlet channel.

A high-pressure mixing device is also known from EP 0879685, of the same applicant, which has been duly modified to allow the injection of two polyurethane components radially into a mixing chamber, as well as the feeding of a third component which is made to flow along a narrow annular chamber in communication with a mixing chamber.

As clearly described and shown in the drawings, the device comprises a mixing chamber into which injection ducts for a first and a second polyurethane component open radially, and a hydraulically controlled slide valve for opening and closing the mixing chamber; the slide valve is conformed with a longitudinal hole which ends in a narrow orifice axially arranged to the mixing chamber.

Inside the longitudinal hole of the slide valve slides a cleaning pin having a diameter smaller than the diameter of the slide valve hole, in order to define a narrow annular feeding chamber for a third polyurethane component, which extends into the same slide valve.

A similar solution proved advantageous since the axial feeding of the third component directly into the mixing chamber, i.e. at a right-angle to the radial jets of the other two components, allows considerable improvement in mixing, by simply modifying a usual mixing device, simultaneously maintaining the self-cleaning condition typical of this type of mixing device.

However, a similar solution proved in practice to be suitable solely in cases in which the third component to be fed axially into the mixing chamber consists of an extremely fluid liquid, or has a low viscosity such as not to require excessively high pressures to overcome the pressure drop caused by passage along the narrow path of the annular chamber of the slide valve which opens and closes the mixing chamber.

Various attempts to feed a highly viscose resin or a resin with a powdered filler material with a similar mixing device proved to be unsuccessful, since feeding of the filled resin through a narrow and long annular passage required excessively high pressures, both to overcome the higher drop pressure and to overcome the strong frictional forces deriving from accumulation of the filler along the annular chamber. Also, the quantity of filler which could be fed was relatively modest and the particles of the filler material were damaged by the strong energy necessary to feed the flow.

It would therefore be desirable to further improve a similar high-pressure mixing device, in order to make it suitable for mixing two or more polyurethane components with a powdered or granulated or flaked filler material, and/or with a chemically aggressive additive, by a solution which maintains an extremely simple structure of the mixing device, which considerably reduces the frictional forces and the pressure drop, consequently allowing a feeding of metered and comparatively high quantities of a filler material and/or additive, with relatively low pressures, considerably lower than the feeding pressures usually require for radially injecting the polyurethane components.

The above solution also makes it possible to use pumps and other feeding devices particularly suitable for highly viscose fluids and/or those characterized by a chemically aggressive and/or abrasive action, compared with traditional high-pressure pumps and feeding devices; it also allows use of pumps provided with pumping elements suitably conformed to avoid breakage or damage of the graphite flakes or other fillers of intumescent materials used to increase the reaction to fire of the polyurethane manufactured articles.

### BRIEF DESCRIPTION OF THE INVENTION

According to a first aspect of the invention, a method for high-pressure mixing of polyurethane component resins has been provided, in which at least a first and a second component are radially injected into a mixing chamber of a mixing device, in which a slide valve member axially slides, the slide valve being conformed with a longitudinal hole for guiding an axially movable pin, and in which at least a third polyurethane component is partially pre-mixed with a powdered, granulated or flaked filler material, and/or with an additive, characterized by the steps of:

providing the slide valve, close to its fore end, with a feeding chamber having an outlet hole or short duct which extends longitudinally towards the mixing chamber;

feeding the third polyurethane component pre-mixed with the filler material, and/or additive, directly from at least one side into the feeding chamber, in a position close to the fore end of the slide valve; and

injecting the third polyurethane component and the pre-mixed filler material, and/or additive, from the feeding chamber longitudinally into the mixing chamber of the mixing device.

According to another aspect of the invention, a high-pressure mixing device has been provided for mixing liquid polyurethane components, the device comprising:
a mixing chamber communicating with a discharge duct;
at least a first and a second hole or nozzle for injecting a first and a second polyurethane component, radially oriented towards the mixing chamber;
a valving member axially sliding in the mixing chamber, the valving member comprising a longitudinal guide bore for a cleaning pin; and
means for feeding into the mixing chamber at least a third polyurethane component pre-mixed with a filler material and/or an additive, characterized in that the means for feeding the third polyurethane component comprise:

a feeding chamber close to the fore end of the valving member, between the longitudinal guide bore for the cleaning pin and an outlet hole;

said feeding chamber comprising an inlet hole for feeding the third polyurethane component and the pre-mixed filler and/or additive, on at least one side of the feeding chamber.

Although the mixing device according to this invention may be used to feed and mix polyurethane components with fillers and/or additives of various natures, from tests conducted good results have been obtained in production of molded items in rigid polyurethane foams comprising intumescent foliated graphite filler, having high characteristics of resistance to fire and self-extinguishing.

### BRIEF DESCRIPTION OF THE DRAWINGS

These and further characteristics and advantages of the high-pressure mixing method and device according to this invention will result from the following description and from the drawings, in which:

FIG. 1 is a longitudinal section according to line 1-1 of FIG. 2 of the mixing device during powering;

FIG. 2 is a cross sectional view according to line 2-2 of FIG. 1;

FIG. 3 is an enlarged detail of FIG. 1;

FIG. 4 is an enlarged detail similar to FIG. 3, with the mixing device in the recirculation phase;

FIG. 5 is an enlarged detail similar to FIG. 3, for a first variant of the invention;

FIG. 6 is an enlarged detail similar to FIG. 3, for a second variant of the invention.

### DETAILED DESCRIPTION OF THE INVENTION

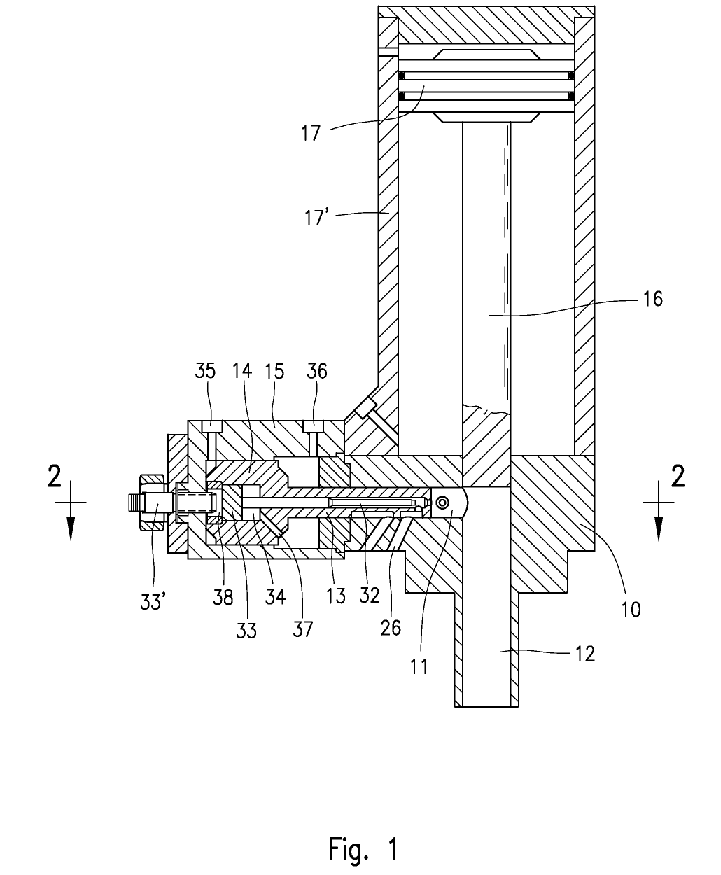

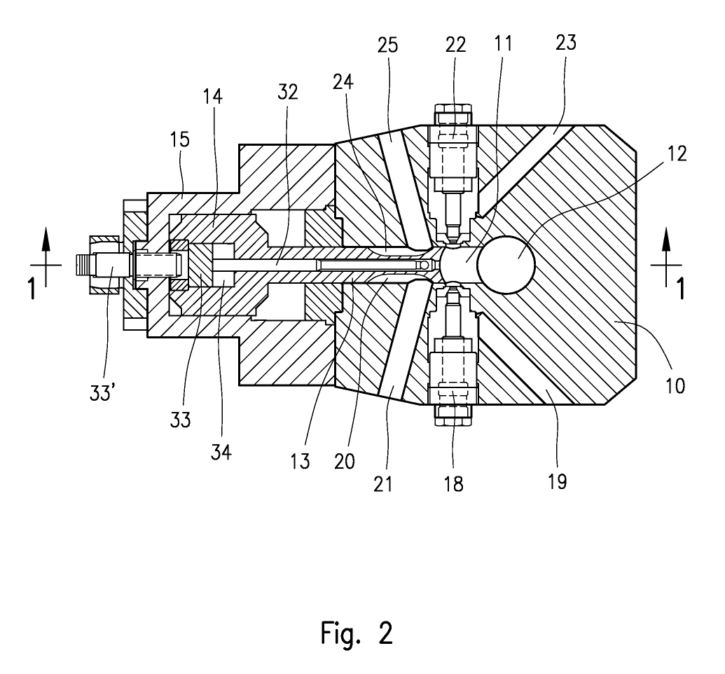

As shown in FIGS. 1 and 2, the high-pressure mixing device comprises, in a manner known in itself, a body 10 having a mixing chamber 11 which communicates frontally with a discharge duct 12 positioned at 90°.

The mixing chamber 11 extends backwards with a guide hole for a slide valve 13, controlled by the piston 14 of a first hydraulic cylinder 15, to be moved between a rear position for opening the mixing chamber 11, in which it allows delivery or powering of a polyurethane mixture, as shown in FIGS. 1, 2 and 3, and a fore position for the closure of the mixing chamber 11, as shown in FIG. 4, in which expects the residual mixture remaining in the mixing chamber.

With reference number 16 in FIG. 1 a cleaning device sliding longitudinally into the delivery duct 12 has also been indicated, controlled by piston 17 of a second hydraulic cylinder 17′.

According to the example being considered, as shown in FIG. 2, the mixing device comprises a first radial injector 18 for a first polyurethane component A, for example a polyole fed through a duct 19, which may be recirculated towards a storage tank, through a longitudinal slot 20 and a duct 21 in the fore position of the slide valve 13, in a manner known in itself.

The mixing device comprises also a second radial injector 22 for feeding a second polyurethane component B, for example an isocyanate suitable to chemically react with the component A to form a polyurethane mixture; component B is fed through a duct 23 and is recirculated to a respective storage tank through a slot 24 and a duct 25. The opposite radial position of the two injectors 18 and 22 allows an intimate mixing, by impingement and turbulence of the two polyurethane components A and B.

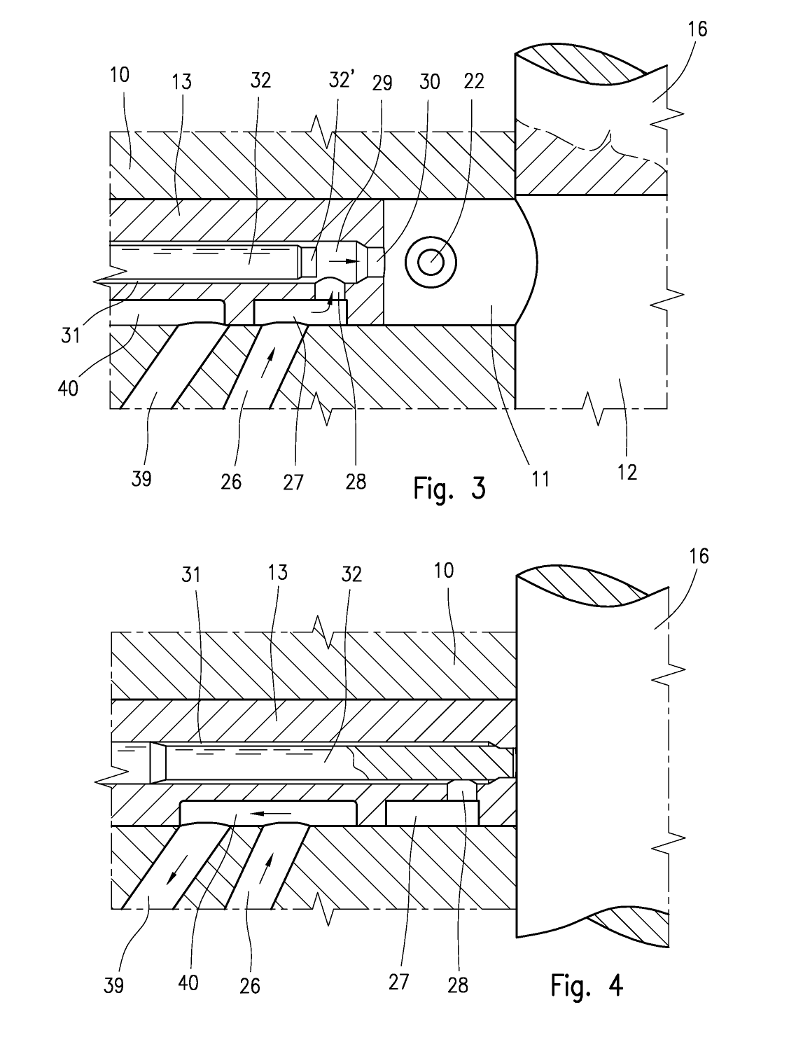

The polyurethane components A and B to be radially injected into the mixing chamber 11, are fed to the nozzles 18, 22 with a high pressure, for example, a pressure of 12-24 MPa or higher; according to this invention, as shown in FIG. 1 and in the enlarged detail of FIG. 3, a third polyurethane component C pre-mixed with a powdered or flaked filler material, such as tumescent foliated graphite, or pre-mixed with a chemical additive, is injected axially into the mixing chamber 11 through the feeding chamber 11 of the slide valve 13, by a solution which allows considerable reduction of frictional forces and pressure drops, as well as the feeding of the pre-mixed component C at a relatively low pressure, lower than the one of the polyurethane components A and B, for example a pressure ranging between 1 MPa and 15 MPa; in this regard, it is specified that the third component C may be different from the components A and B, or may consist in one of the said first and second components.

More specifically, component C and the pre-mixed filler are fed through an inlet duct 26, a longitudinal slot 27 and a radial hole 28, to be introduced into a feeding chamber 29, close to the fore end of the slide valve 13; the filler and third component feeding chamber 29 opens into the mixing chamber 11 through a longitudinal outlet hole 30 at the fore end of the slide 13, having a maximum length equal to or lower than two and half times its diameter.

The feeding chamber 29, as explained below, may have any shape suitable for an adequate downflow of the filled polyurethane component from at least one side inlet point towards the outlet hole 30; in the case of FIGS. 1, 2 and 3, the feeding chamber 29 has a cylindrical shape which extends axially into the slide valve 13 for a length equal to or slightly higher than its diameter.

A longitudinal hole 31, of diameter equal to the diameter of the feeding chamber 29, or lower, extends longitudinally into the slide valve 13, behind the feeding chamber 29. A pin 32 for cleaning and closing the outlet hole 30, axially slides into the longitudinal hole 31, between a rear position shown in FIG. 3, behind the chamber 29, to open the outlet hole 30, and a fore position shown in FIG. 4, in which it cleans and closes the outlet hole 30. The longitudinal outlet hole 30 may be axially aligned with the mixing chamber 11, or may be positioned on a side parallel to the longitudinal axis of the mixing chamber.

The cleaning pin 32 is connected to the piston 33 of a hydraulic cylinder 34 directly inside the piston 14 of hydraulic cylinder 15 which controls the slide valve 13; the chambers of the two hydraulic cylinders 15 and 34 communicate with each other and with pressurized oil inlet and outlet openings 35, 36, through internal passages 37, 38, to control in sequence the slide valve 13 and pin 32 between the rear position, shown in FIGS. 1, 2 and 3, in which component C may flow into the mixing chamber 11, and the fore position of FIG. 4, in which the cleaning pin 32 ejects the residual of component C remaining in chamber 29, and in which the shaped end 32′ of the pin 32 cleans and closes the outlet hole 30. At the same time, in the fore position of FIG. 4, the slide valve 13 eject the residual mixture from the mixing chamber 11, connecting the feeding duct 26 of component C with the recirculation duct 39 through a longitudinal slot 40.

The cleaning pin 32 may also take an intermediate position to the one in FIGS. 3 and 4, in which partially throttles the flow of the component from the feeding chamber 29 to the outlet hole 30; this may be obtained by axially adjusting the position of a stop element 33′ to stop the piston 33 of cleaning pin 32, for example screwing it to axially protrude into the chamber of the control cylinder 34.

The working of the high-pressure mixing device is briefly as follows: in the forward condition of the slide valve 13 and pin 32, chambers 11 and 29 are closed, whereas polyurethane components A, B and C are recirculated towards respective storage tanks. Conversely, in the rear condition of FIGS. 1, 2 and 3 of slide valve 13 and cleaning pin 32, the chamber 11 is open and in fluid communication with injectors 18 and 22 for components A and B, whereas chamber 29 is open and in fluid communication with duct 26 of component C pre-mixed with the filler material and/or with a suitable chemical additive; in this condition, the jets of the two components A and B fed at an initial pressure and speed, radially impinge each other, creating a highly turbulent regime in the mixing chamber 11, whereas component C is axially fed at a pressure and speed lower than those of components A and B, and intimately mixed with the other components A and B for a swirling action in the mixing chamber 11.

In this manner, the resulting mixture which flows from the mixing chamber 11 into the discharge duct 12 contains a metered quantity of a filler material and/or an additive, homogenously dispersed into the mixture while it is fed into a cavity of a mold.

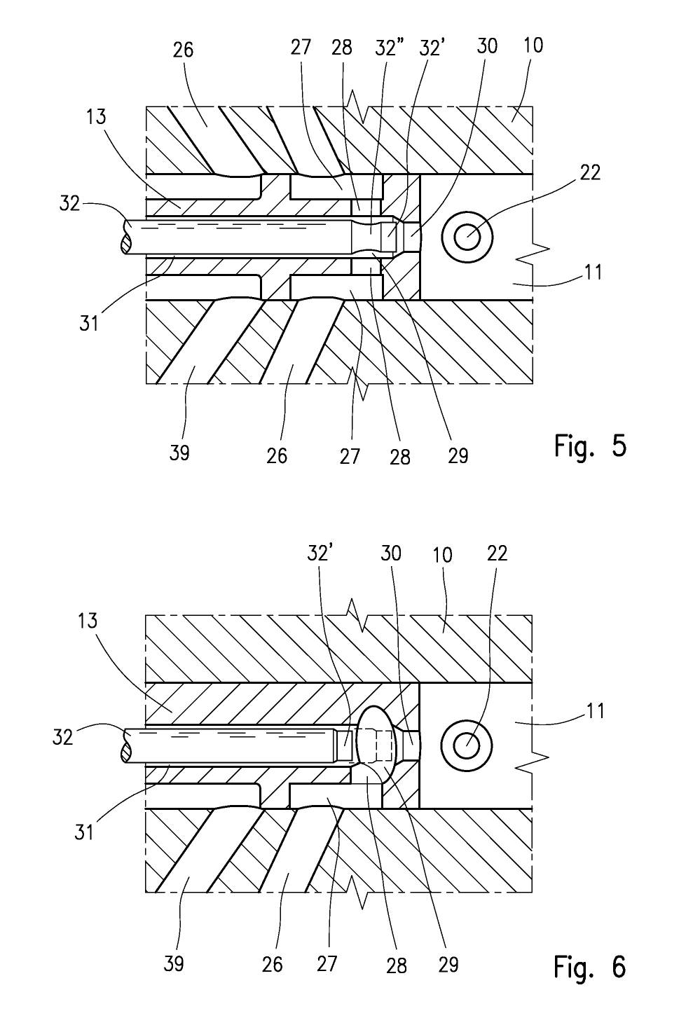

FIG. 5 shows a first variant of the mixing device, relating to the feeding chamber 29 and the cleaning pin 32; in FIG. 5, the same reference numbers have been used as the previous figures, to indicate similar or equivalent parts.

The solution in FIG. 5 differs from the previous solution in that the feeding chamber 29 has two inlet holes 28 positioned at 180° to each other, to simultaneously feed two flows of a polyurethane component and filler material, or flows of different polyurethane components.

The solution in FIG. 5 differs also in that the cleaning pin 32, behind its end 32′, has an annular throat 32″ which facilitates the inlet and flow of the filled polyurethane component, or components, into the same feeding chamber and the homogenous downflow towards the mixing chamber.

FIG. 5 also shows an intermediate position of cleaning pin 32, in which the end 32′ partialises the passage between the feeding chamber 29 and the outlet hole 30.

FIG. 6 shows a second variant of the feeding chamber 29; the same reference numbers used in the previous figures have also been used in FIG. 6, to indicate similar or equivalent parts.

The solution of FIG. 6 differs from the solution of FIGS. 3 and 4 in that now the feeding chamber 29 has a cross dimension higher than guide hole 31 of cleaning pin 32; in the case shown, the feeding chamber 29 is barrel-shaped, but could also be cylindrical or have any other shape.

From what is stated and shown in the example of FIGS. 1 to 6, it is therefore clear that a high-pressure mixing method and device have been provided which allow substantial improvement in the feeding and mixing conditions of polyurethane components having powdered or flaked filler materials and/or additive, variously adaptable to specific application requirements, without substantially changing the general features of the mixing device and its operative method.

Therefore, other changes or variants may be made to the entire mixing device equipment or parts thereof without departing from the claims

What we claim is:

1. A method for high-pressure mixing polyurethane resin components, in which at least a first and a second polyurethane component are radially injected into a mixing chamber of a mixing device in which a valving member axially slides, the valving member having a longitudinal bore for guiding an axially movable cleaning pin, and in which at least a third polyurethane component is pre-mixed with a powdered, granulated or flaked filler material and/or with an additive, comprising the steps of:
conforming the valving member, close to it front end, with a feeding chamber having an axial outlet hole which extends towards the mixing chamber;
feeding the third polyurethane component pre-mixed with the filler material, and/or additive, directly from at least one side, into the feeding chamber in a position close to the fore end of the valving member; and
injecting the third polyurethane component and the pre-mixed filler material, and/or additive, from the feeding chamber longitudinally into the mixing chamber of mixing device.

2. The method according to claim 1, wherein the first and second polyurethane components radially injected into the mixing chamber are fed at a first pressure and speed, and in that the third polyurethane component pre-mixed with the filler material and/or the additive is fed at a pressure and speed lower than the previous ones.

3. The method according to claim 2, wherein the feeding pressure of the radially injected first and second components, ranges from 12 to 24 MPa, while the pressure of the third polyurethane component ranges from 1 to 15 MPa.

4. The method according to claim 1, wherein the third polyurethane component premixed with the filler material and/or the additive, is different from the first and second polyurethane components radially injected into the mixing chamber.

5. The method according to claim 1, wherein the third polyurethane component pre-mixed with the filler material and/or the additive, consists of one of said first and second polyurethane components radially injected into the mixing chamber.

6. A high-pressure mixing device, for mixing liquid polyurethane resin components, comprising:
a mixing chamber communicating with a discharge duct;
at least a first and a second hole or nozzle for injecting a first and a second polyurethane components, radially oriented towards the mixing chamber;
a valving member axially sliding in the mixing chamber, the valving member comprising a longitudinal guide bore for a cleaning pin; and
means for feeding into the mixing chamber at least a third polyurethane component pre-mixed with a filler material and/or an additive, wherein the means for feeding the third polyurethane component comprise:
a feeding chamber close to the fore end of the valving member, between the longitudinal guide bore for the cleaning pin and an outlet hole;
said feeding chamber comprising an inlet hole for feeding the third polyurethane component and the pre-mixed filler and/or additive, on at least one side of the feeding chamber.

7. The high-pressure mixing device according to claim 6, wherein the valving member comprises a longitudinal slot communicating with the inlet hole for the third component into the feeding chamber, and a recirculation slot on a same side of the valving member.

8. The high-pressure mixing device according to claim 6, wherein the feeding chamber comprises at least a first and a second angularly spaced inlet holes.

9. The high-pressure mixing device according to claim 6, wherein the valving member and the cleaning pin for the feeding chamber, are operatively connected to respective sequentially operated hydraulic control cylinders, to selectively move the valving member and the cleaning pin between a forward closed condition, and a backward open condition of the mixing chamber, respectively of the feeding chamber of the mixing device.

10. The high-pressure mixing device according to claim 9, wherein the valving member is operatively connected to a piston member of a first hydraulic control cylinder, and in that the cleaning pin is operatively connected to a piston member of a second hydraulic cylinder within the piston member of the control cylinder of the valving member, and conduit means for conjointly feeding the two control cylinders, conformed to provide an appropriate hydraulic resistance to coordinate a respective shifting actuation.

11. The high-pressure mixing device according to claim 6, wherein the feeding chamber has a cylindrical shape having a diameter corresponding to or larger than the diameter of the guide bore for the cleaning pin.

12. The high-pressure mixing device according to claim 11, wherein the cleaning pin is provided with a annular groove close to its fore end.

13. The high-pressure mixing device according to claim 6, wherein the feeding chamber has a cross dimension greater than the guide bore for the cleaning pin.

14. The high-pressure mixing device according to claim 7, in which the outlet hole of the feeding chamber has a diameter, wherein the length of the outlet hole is equal to or smaller than two and a half times the diameter of the outlet hole.

15. The high-pressure mixing device according to claim 7, wherein the outlet hole of the feeding chamber extends parallel or coaxially to the longitudinal axis of the mixing chamber.

16. The high-pressure mixing device according to claim 7, wherein the valving member and the cleaning pin are operatively connected to the piston member of a respective hydraulic control cylinder, an adjustable stop member being provided for stopping the piston member of the control cylinder in a retracted position of the cleaning pin.
